(19) United States
(12) Patent Application Publication
(10) Pub. No.: US 2019/0383419 A1
(43) Pub. Date: Dec. 19, 2019

(54) Anti-leakage self-sealing valve

(71) Applicant: Jiangsu Suyan Valve Machinery Co.,Ltd, Jiangsu Province 224500 (CN)

(72) Inventors: Zhenghai Han, Jiangsu Province 224500 (CN); Wenhao Han, Jiangsu Province 224500 (CN); Wenwen Han, Jiangsu Province 224500 (CN); Yu Han, Jiangsu Province 224500 (CN); Sheng Han, Jiangsu Province 224500 (CN)

(21) Appl. No.: 16/033,895

(22) Filed: Jul. 12, 2018

(30) Foreign Application Priority Data
Jun. 19, 2018 (CN) 201810630606.1

(51) Int. Cl. F16K 31/53; F16K 31/60

(52) U.S. Cl. CPC F16K 31/53; F16K 31/60

(57) ABSTRACT

The invention relates to a valve, in particular to an anti-leakage self-sealing valve which comprises a valve support, a rotary gear, a lower connecting plate, an upper connecting plate, a pinion, an upper closing plate, a lower closing plate and a conical connecting cylinder, a connecting support, a connecting cylinder, a clamping mechanism, a disassembling mechanism, a connecting rod and a one-way mechanism.

### CROSS REFERENCE TO RELATED APPLICATION

This application claims priority from Chinese Patent Application No. 201810630606.1, filed Jun. 19, 2018 and entitled “ANTI-LEAKAGE SELF-SEALING VALVE” the disclosure of which is hereby incorporated entirely herein by reference.

### FIELD OF THE INVENTION

The invention relates to a valve, in particular to an anti-leakage self-sealing valve.

### BACKGROUND OF THE INVENTION

For example, the patent number CN201720091458.1 is an anti-leakage self-sealing valve which comprises a valve body. An upper cover is arranged at the top end of the valve body, and a first groove is formed in the bottom of the upper cover, a second groove is formed in the top of the valve body, and a fixing pin is arranged in the first groove, a fixing hole is formed in the second groove, and the fixing hole is matched with the fixing pin, a sealing ring is arranged at the top of the upper cover, and a vertical downward hollow pipe is arranged in the middle of the sealing ring, a valve rod is arranged inside the hollow pipe, and a valve hand wheel is connected to the top of the valve rod, and the bottom of the valve hand wheel is fixedly connected with the upper cover. The utility model is not capable of being quickly mounted and disassembled, and the leakage prevention cannot be achieved by limiting the flowing direction of the liquid.

### SUMMARY OF THE INVENTION

The invention aims to provide an anti-leakage self-sealing valve, quick mounting and dismounting can be realized, and the leakage prevention can be prevented by limiting the flowing direction of the liquid.

The purpose of the invention is realized by the following technical scheme:

A valve support, a rotary gear, a lower connecting plate, an upper connecting plate and a pinion, an upper closing plate, a lower closing plate and a conical connecting cylinder, a connecting support, a connecting cylinder, a clamping mechanism and a disassembling mechanism, a connecting rod and a one-way mechanism. The valve support and the rotary gear are respectively and symmetrically provided with two, and the two rotary gears are respectively and rotationally connected to the inner sides of the two valve supports, the left end and the right end of the lower connecting plate are fixedly connected to the two valve supports respectively. The left end and the right end of the upper connecting plate are fixedly connected to the two valve supports respectively, the upper connecting plate is positioned at the upper end of the lower connecting plate; two pinions which are symmetrically arranged in an up-and-down mode, the two ends of the two pinions are respectively engaged with the inner sides of the two rotary gears, and the upper closing plate is connected to the pinion positioned at the upper end through threads; the lower closing plate is connected to the pinion positioned at the lower end through threads, the upper end of the upper closing plate is slidably connected to the upper connecting plate, and the lower end of the lower closing plate is slidably connected to the lower connecting plate; two conical connecting cylinders are symmetrically arranged on the left side and the right side, the outer ends of the two conical connecting cylinders are fixedly communicated with the two valve supports respectively, the inner ends of the two conical connecting cylinders are fixedly communicated with the left end and the right end of the connecting support respectively, the lower end of the upper closing plate is slidably connected to the connecting support, the upper end of the lower closing plate is slidably connected to the connecting support, two connecting cylinders are symmetrically arranged on the left side and the right side, four clamping mechanisms are symmetrically arranged, and the four clamping mechanisms are respectively and slidably connected to the two valve supports the front end and the rear end of the outer side, a compression spring I is arranged between the four clamping mechanisms and the valve support, the two connecting cylinders are respectively clamped on the outer sides of the two valve supports through four clamping mechanisms, the disassembling mechanism is slidably connected to the upper connecting plate and a compression spring II is arranged between the disassembling mechanism and the upper connecting plate, four connecting rods are symmetrically arranged, the inner ends of the four connecting rods are hinged to the disassembling mechanism, and the four rods is hinged to the four clamping mechanisms respectively, the inner ends of the four connecting rods are inclined upwards, the left end of the one-way mechanism is fixedly connected to the valve support positioned at the right end, and the one-way mechanism is in interference fit with the connecting cylinder positioned at the right end.

As a further optimization of the technical scheme, the invention discloses an anti-leakage self-sealing valve: the valve support comprises a valve cylinder, a valve lower support and a valve side plate I; a valve side plate II and a circular through hole I, the lower support of the valve is fixedly connected to the lower end of the valve cylinder, four valve side plates I are symmetrically arranged, the four valve side plates I are fixedly connected to the front end and the rear end of the valve cylinder respectively, valve side plates II are fixedly connected between the two valve side plates I at the front end and the rear end, circular through holes I are formed in the two valve side plates II.

As a further optimization of the technical scheme, the invention discloses an anti-leakage self-sealing valve: the rotary gear comprises a rotating gear body, a rotating column, a rotating handle, a gear groove and a mounting groove I; a sealing gasket is arranged in the mounting groove I, a plurality of rotating columns are arranged, a plurality of rotating columns are uniformly and fixedly connected to the rotating gear body in the circumferential direction, a rotating handle is fixedly connected to the outer side of the plurality of rotating columns, the gear groove and the mounting groove □ are respectively arranged at the left and right ends of the rotating gear body, two rotary gears are symmetrically arranged on the left side and the right side, the outer ends of the two rotating gear bodies pass through the two mounting grooves I respectively is connected to the inner side of the two valve cylinders in a rotating mode.

As a further optimization of the technical scheme, the invention discloses an anti-leakage self-sealing valve: the left end and the right end of the lower connecting plate are fixedly connected to the two valve cylinders respectively; two circular through holes II are formed in the upper connecting plate, the left end and the right end of the upper connecting plate are fixedly connected to the two valve cylinders respectively, the left end and the right end of the two pinions are respectively meshed with the teeth in the two gear grooves.

As a further optimization of the technical scheme, the invention discloses an anti-leakage self-sealing valve: the upper closing plate comprises an upper arc plate, an upper threaded rod and a clamping plate; the upper threaded rod and the clamping plate are fixedly connected to the upper end and the lower end of the upper arc plate respectively, the upper threaded rod is connected to the pinion at the upper end by threads, the upper end of the upper threaded rod is slidably connected to the upper connecting plate; the lower closing plate comprises a lower threaded rod, a lower arc plate and a clamping groove, clamping groove is arranged at the upper end of lower arc plate, the lower threaded rod is fixedly connected to the lower end of the lower arc plate, the lower threaded rod is connected to the pinion at the lower end by threads, the lower end of the lower threaded rod is slidably connected to the lower connecting plate, thread rotation direction of upper threaded rod and lower threaded rod.

As a further optimization of the technical scheme, the invention discloses an anti-leakage self-sealing valve: the connecting support which comprises a communication support body, a communication side plate and a circular through hole lit, two communication side plates are symmetrically arranged on the left side and the right side, both communication side plates are fixedly connected in the communication support body, two communication side plates forming a sealing sliding groove, two circular through holes III are symmetrically arranged in an up-and-down mode, two circular through holes III are internally provided with rotary rubber sealing rings, two circular through holes III are respectively arranged at the upper end and the lower end of the communication support body, the inner ends of the two conical connecting cylinders are respectively fixed and communicated with the left end and the right end of the communication support body, the outer ends of the two conical connecting cylinders are respectively fixed and communicated in the two valve cylinders, the upper arc plate and the lower arc plate pass through two circular through holes □ respectively is in sliding connection with the two communication side plates to form a sealing sliding groove.

As a further optimization of the technical scheme, the invention discloses an anti-leakage self-sealing valve: the connecting cylinder comprises a connecting cylinder body, a quick clamping block and a mounting groove II; the sealing ring is arranged in mounting groove II, two quick clamping blocks are front and back symmetric arrangement, two quick clamping blocks are fixedly connected to the front end and the rear end of the right side of the connecting cylinder respectively, mounting groove II is arranged on the right side of the connecting cylinder, the two connecting cylinders are respectively communicated with the outer side of the two valve cylinders through two mounting grooves II.

As a further optimization of the technical scheme, the invention discloses an anti-leakage self-sealing valve: the clamping mechanism comprises a clamping column, a connecting rod and a clamping body; the connecting rod and the clamping body are fixedly connected to the front end and the rear end of the clamping column respectively, four clamping columns are respectively slidably connected in four circular through holes I, four clamping bodies are respectively clamped on four corresponding quick clamping blocks, compression springs I are arranged on the four clamping columns, the compression spring I is positioned between the clamping body and the valve side plate II.

As a further optimization of the technical scheme, the invention discloses an anti-leakage self-sealing valve: the disassembling mechanism comprises a disassembling plate, a disassembling sliding column and a disassembling side plate; two disassembling sliding column and a disassembling side plate are symmetrically arranged on the left side and the right side, the upper ends of the two disassembling sliding columns are fixedly connected to a disassembling plate, the middle ends of the two disassembling side plates are fixedly connected to the left end and the right end of the disassembling plate respectively, two disassembling sliding columns are respectively slidably connected in two circular through holes II, two disassembling sliding columns are respectively sleeved with a compression spring II, the compression spring II is positioned between the disassembling plate and the upper connecting plate, the inner ends of the four connecting rods are hinged to the front end and the rear end of the two disassembling side plates respectively.

As a further optimization of the technical scheme, the invention discloses an anti-leakage self-sealing valve: the one-way mechanism comprises a one-way plate, a one-way conical plate and a rectangular column; a rectangular column is slidably connected to a one-way plate, one-way conical plate is fixedly connected to the left end of rectangular column, compression spring □ is on rectangular column, the compression spring □ is positioned between the one-way plate and the one-way conical plate, one-way plate is provided with a plurality of through holes, one-way plate is fixedly connected in valve cylinder positioned at the right end, one-way conical plate is positioned in connecting cylinder at right end, the inner diameter of the connecting cylinder is smaller than the inner diameter of the valve cylinder.

The anti-leakage self-sealing valve disclosed by the invention has the beneficial effects:

An anti-leakage self-sealing valve, the two communicated side plates in the connecting support can be controlled to form a sealing sliding groove switch by manually rotating the rotary gear, liquid in the connecting support is controlled to circulate, and the two connecting cylinders can be rapidly installed through the four clamping mechanisms, and the two connecting cylinders can be quickly detached by manually pushing the disassembling mechanism to move downwards to drive the four connecting rods to move, the one-way mechanism can control the flow direction of the liquid in the device to be better than the leakage prevention of the liquid in the device.

### BRIEF DESCRIPTION OF THE FIGURES

The present invention will be described in further detail with reference to the accompanying drawings and the specific implementation method.

FIG. 1 is a schematic structural diagram of an anti-leakage self-sealing valve of the invention;

FIG. 2 is a schematic structural diagram of a cross-sectional structure of an anti-leakage self-sealing valve of the present invention

FIG. 3 is a schematic structural diagram of a cross-sectional structure of an anti-leakage self-sealing valve of the present invention

FIG. 4 is a schematic structural diagram of a valve support of the present invention;

FIG. 5 is a schematic structural diagram of a rotary gear of the present invention;

FIG. 6 is a schematic structural diagram of a left view of a rotary gear of the present invention;

FIG. 7 is a schematic structural diagram of a lower connecting plate of the present invention;

FIG. 8 is a schematic structural diagram of an upper connecting plate of the invention;

FIG. 9 is a schematic structural diagram of an upper closing plate according to the invention;

FIG. 10 is a schematic structural diagram of a lower closing plate of the present invention

FIG. 11 is a schematic structural diagram of a conical connecting cylinder of the present invention;

FIG. 12 is a schematic structural diagram of a connecting support according to the present invention;

FIG. 13 is a schematic structural diagram of a sectional structure of a connecting support of the present invention;

FIG. 14 is a schematic structural diagram of a connecting cylinder of the present invention;

FIG. 15 is a schematic structural diagram of a clamping mechanism of the present invention;

FIG. 16 is a schematic structural diagram of a disassembling mechanism of the present invention;

FIG. 17 is a schematic structural diagram of a one-way mechanism of the present invention;

FIG. 18 is a schematic structural diagram of a one-way mechanism of the present invention;

In Figures: valve support (1), valve cylinder (1-1), valve lower support (1-2), valve side plate □ (1-3), valve side plate □ (1-4), circular through hole □ (1-5); rotary gear (2), rotating gear body (2-1), rotating column (2-2), rotating handle (2-3), gear groove (2-4), mounting groove □ (2-5), lower connecting plate (3), upper connecting plate (4), circular through holes □ (4-1), pinion (5), upper closing plate (6), upper arc plate (6-1), upper threaded rod (6-2), clamping plate (6-3), lower closing plate (7), lower threaded rod (7-1), lower arc plate (7-2), clamping groove (7-3), conical connecting cylinder (8), connecting support (9), communication support body (9-1), communication side plate (9-2), circular through hole □ (9-3), connecting cylinder (10), connecting cylinder body (10-1), quick clamping block (10-2), mounting groove □ (10-3), clamping mechanism (11), clamping column (11-1), connecting rod (11-2), clamping body (11-3), disassembling mechanism (12), disassembling plate (12-1), disassembling sliding column (12-2), disassembling side plate (12-3), connecting rod (13), one-way mechanism (14), one-way plate (14-1), one-way conical plate (14-2), rectangular column (14-3).

### DETAILED DESCRIPTION OF THE INVENTION

The present invention is described in further detail below with reference to the accompanying drawings.

Specific Implementation Mode 1:

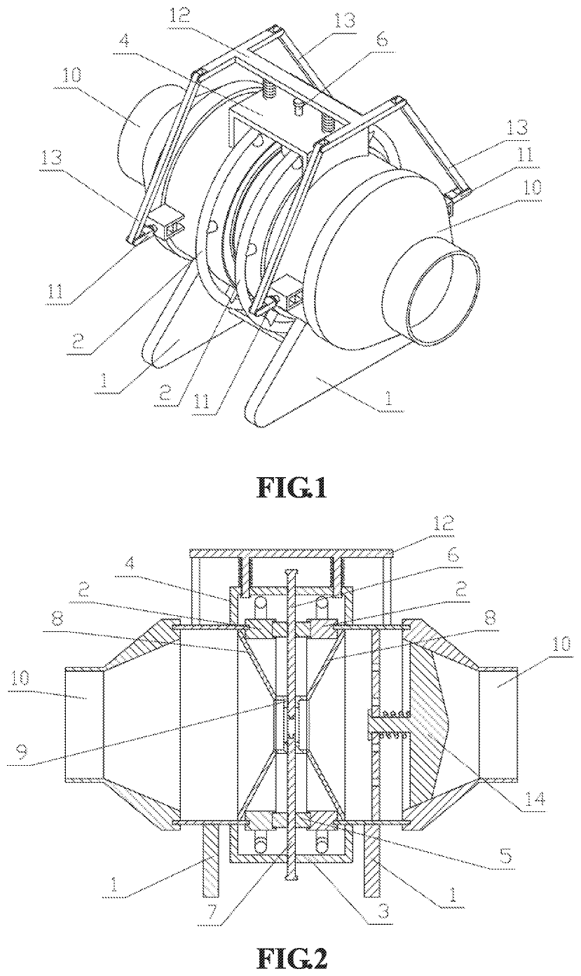

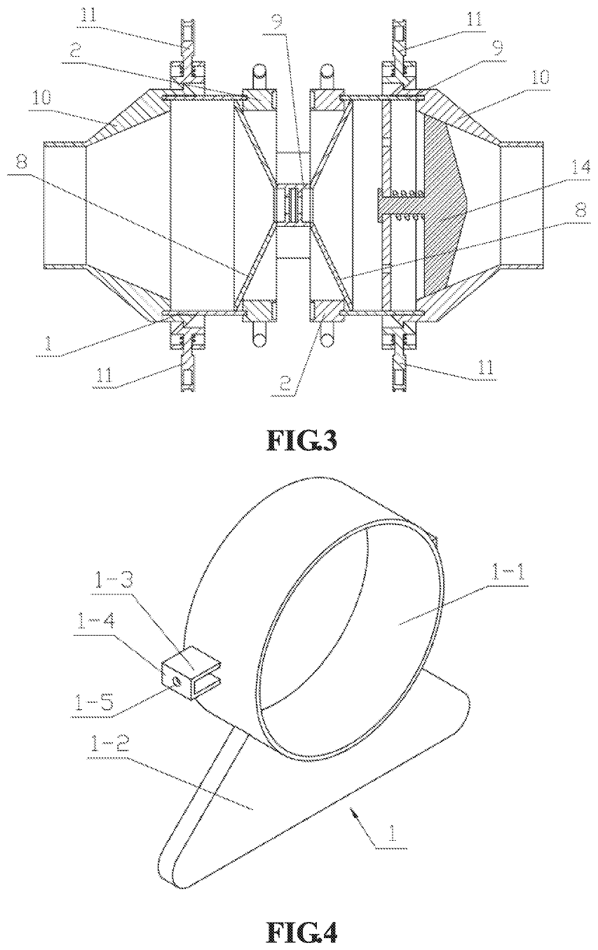

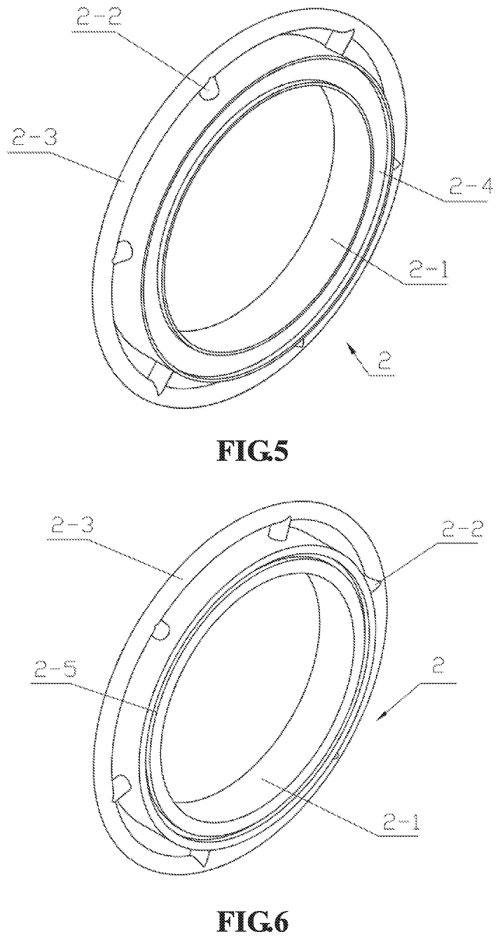

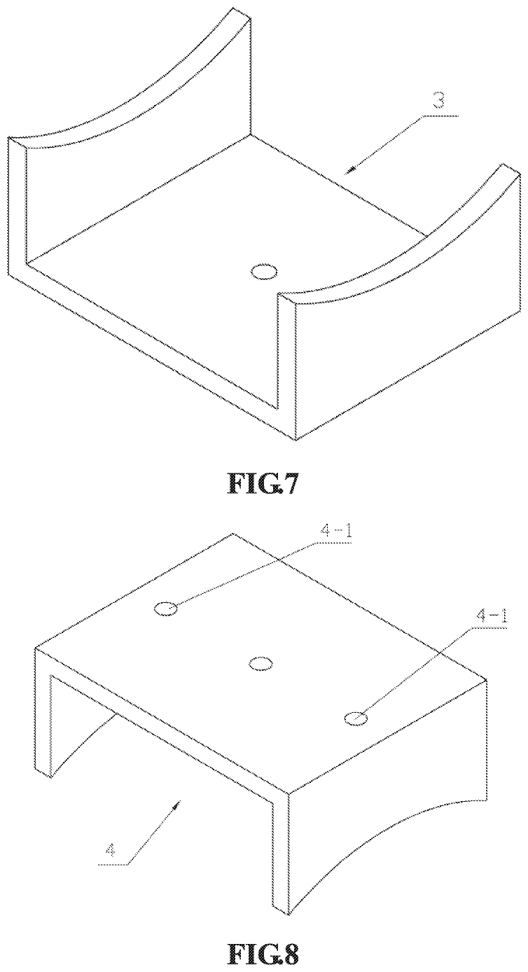

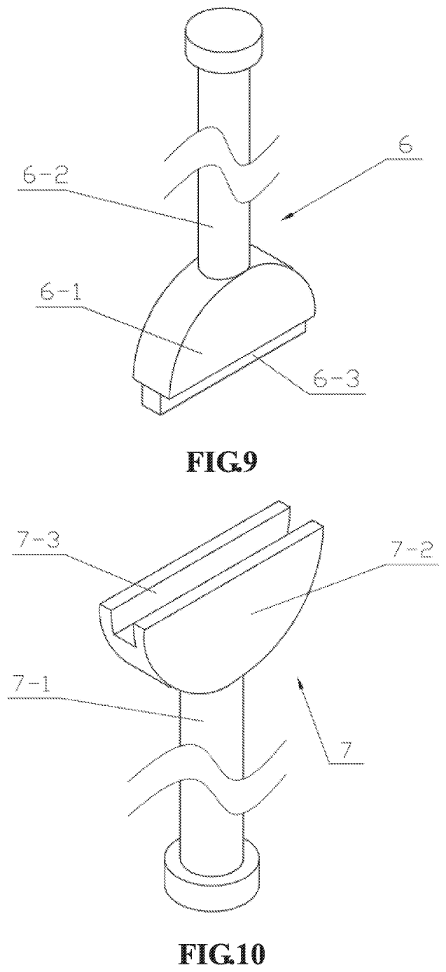

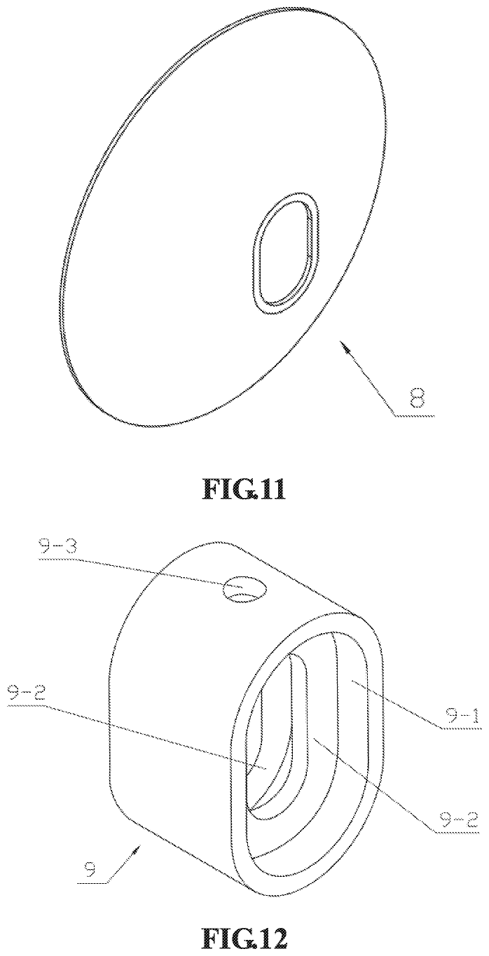

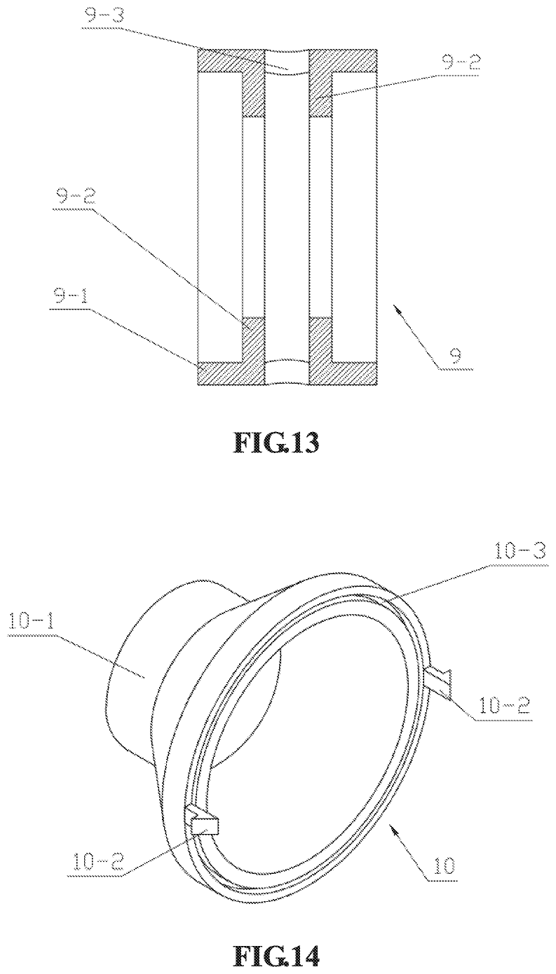

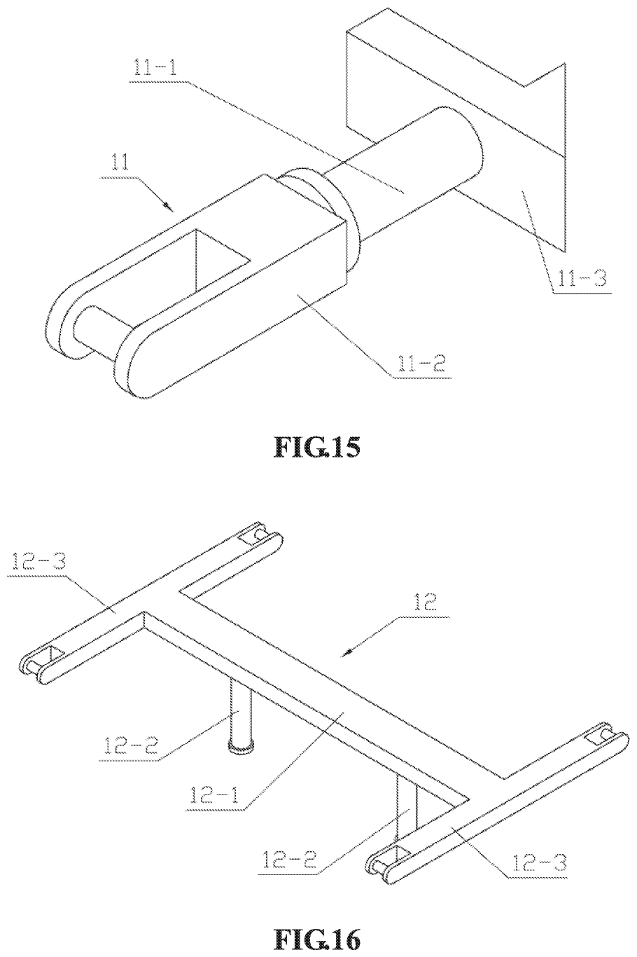

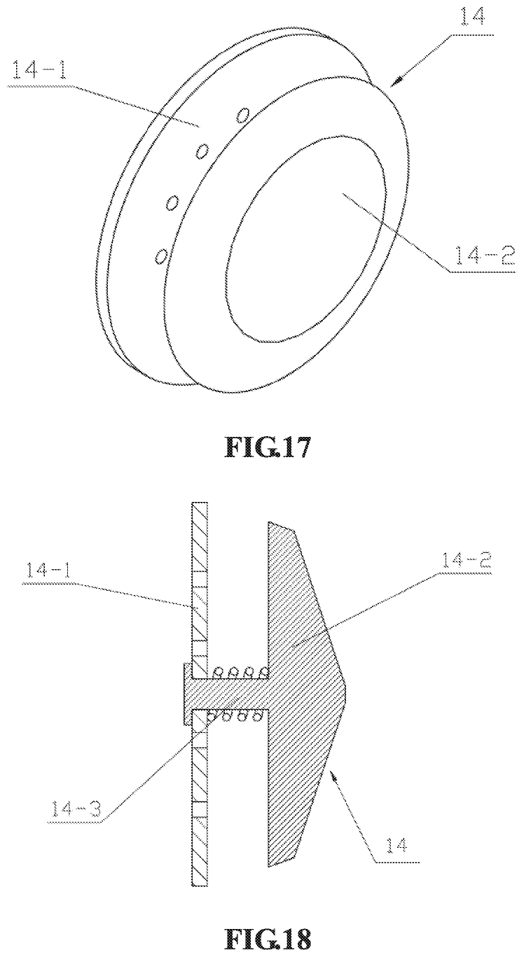

The present embodiment is described below with reference to FIGS. 1-18, the anti-leakage self-sealing valve comprises a valve support 1, a rotary gear 2, a lower connecting plate 3, an upper connecting plate 4 and a pinion 5, an upper closing plate 6, a lower closing plate 7 and a conical connecting cylinder 8, a connecting support 9, a connecting cylinder 10, a clamping mechanism 11 and a disassembling mechanism 12, a connecting rod 13 and a one-way mechanism 14, and is characterized in that the valve support 1 and the rotary gear 2 are respectively and symmetrically provided with two, and the two rotary gears 2 are respectively and rotationally connected to the inner sides of the two valve supports 1, the left end and the right end of the lower connecting plate 3 are fixedly connected to the two valve supports 1 respectively. The left end and the right end of the upper connecting plate 4 are fixedly connected to the two valve supports 1 respectively, the upper connecting plate 4 is positioned at the upper end of the lower connecting plate 3; two pinions 5 which are symmetrically arranged in an up-and-down mode, the two ends of the two pinions 5 are respectively engaged with the inner sides of the two rotary gears 2, and the upper closing plate 6 is connected to the pinion 5 positioned at the upper end through threads; the lower closing plate 7 is connected to the pinion 5 positioned at the lower end through threads, the upper end of the upper closing plate 6 is slidably connected to the upper connecting plate 4, and the lower end of the lower closing plate 7 is slidably connected to the lower connecting plate 3; two conical connecting cylinders 8 are symmetrically arranged on the left side and the right side, the outer ends of the two conical connecting cylinders 8 are fixedly communicated with the two valve supports 1 respectively, the inner ends of the two conical connecting cylinders 8 are fixedly communicated with the left end and the right end of the connecting support 9 respectively, the lower end of the upper closing plate 6 is slidably connected to the connecting support 9, the upper end of the lower closing plate 7 is slidably connected to the connecting support 9, two connecting cylinders are symmetrically arranged on the left side and the right side, four clamping mechanisms 11 are symmetrically arranged, and the four clamping mechanisms 11 are respectively and slidably connected to the two valve supports 1 the front end and the rear end of the outer side, a compression spring I is arranged between the four clamping mechanisms 11 and the valve support 1, the two connecting cylinders 10 are respectively clamped on the outer sides of the two valve supports 1 through four clamping mechanisms 11, the disassembling mechanism is slidably connected to the upper connecting plate 4 and a compression spring II is arranged between the disassembling mechanism 12 and the upper connecting plate 4, four connecting rods 13 are symmetrically arranged, the inner ends of the four connecting rods 13 are hinged to the disassembling mechanism 11, and the four rods 13 is hinged to the four clamping mechanisms 11 respectively, the inner ends of the four connecting rods 13 are inclined upwards, the left end of the one-way mechanism 14 is fixedly connected to the valve support 1 positioned at the right end, and the one-way mechanism 14 is in interference fit with the connecting cylinder 10 positioned at the right end. The two communicated side plates 9-2 in the connecting support 9 can be controlled to form a sealing sliding groove switch by manually rotating the rotary gear 2, liquid in the connecting support 9 is controlled to circulate, and the two connecting cylinders 10 can be rapidly installed through the four clamping mechanisms 11, and the two connecting cylinders 10 can be quickly detached by manually pushing the disassembling mechanism 12 to move downwards to drive the four connecting rods 13 to move, the one-way mechanism 14 can control the flow direction of the liquid in the device to be better than the leakage prevention of the liquid in the device.

Specific Implementation Mode 2:

The present embodiment is described below with reference to FIGS. 1-18, the implementation mode 1 is further described in this embodiment. The anti-leakage self-sealing valve according to claim 1 is characterized in that the valve support 1 comprises a valve cylinder 1-1, a valve lower support 1-2 and a valve side plate □ 1-3; a valve side plate □ 1-4 and a circular through hole □ 1-5, the lower support 1-2 of the valve is fixedly connected to the lower end of the valve cylinder 1-1, four valve side plates □ 1-3 are symmetrically arranged, the four valve side plates □ 1-3 are fixedly connected to the front end and the rear end of the valve cylinder 1-1 respectively, valve side plates □ 1-4 are fixedly connected between the two valve side plates □ 1-3 at the front end and the rear end, circular through holes □ 1-5 are formed in the two valve side plates □ 1-4.

Specific Implementation Mode 3:

The present embodiment is described below with reference to FIGS. 1-18, the implementation mode 2 is further described in this embodiment. The anti-leakage self-sealing valve according to claim 2 is characterized in that the rotary gear 2 comprises a rotating gear body 2-1, a rotating column 2-2, a rotating handle 2-3, a gear groove 2-4 and a mounting groove □ 2-5; a sealing gasket is arranged in the mounting groove □ 2-5, a plurality of rotating columns 2-2 are arranged, a plurality of rotating columns 2-2 are uniformly and fixedly connected to the rotating gear body 2-1 in the circumferential direction, a rotating handle 2-3 is fixedly connected to the outer side of the plurality of rotating columns 2-2, the gear groove 2-4 and the mounting groove □ 2-5 are respectively arranged at the left and right ends of the rotating gear body 2-1, two rotary gears 2 are symmetrically arranged on the left side and the right side, the outer ends of the two rotating gear bodies 2-1 pass through the two mounting grooves I 2-5 respectively is connected to the inner side of the two valve cylinders 1-1 in a rotating mode. During use, the rotating handle 2-3 on one side is rotated manually, and the rotating handle 2-3 is rotated to drive the rotating column 2-2 to rotate, the rotating column 2-2 drives the rotating gear body 2-1 to rotate.

Specific Implementation Mode 4:

The present embodiment is described below with reference to FIGS. 1-18, the implementation mode 3 is further described in this embodiment. The anti-leakage self-sealing valve according to claim 3 is characterized in that the left end and the right end of the lower connecting plate 3 are fixedly connected to the two valve cylinders 1 respectively; two circular through holes II 4-1 are formed in the upper connecting plate 4, the left end and the right end of the upper connecting plate 4 are fixedly connected to the two valve cylinders 1-1 respectively, the left end and the right end of the two pinions 5 are respectively meshed with the teeth in the two gear grooves 2-4. The two rotating gears 2-1 drive the two pinions 5 to rotate, the rotating directions of the two rotating gear bodies 2-1 are opposite; the rotating directions of the two pinions 5 are opposite.

Specific Implementation Mode 5:

The present embodiment is described below with reference to FIGS. 1-18, the implementation mode 4 is further described in this embodiment. The anti-leakage self-sealing valve according to claim 4 is characterized in that the upper closing plate 6 comprises an upper arc plate 6-1, an upper threaded rod 6-2 and a clamping plate 6-3; the upper threaded rod 6-2 and the clamping plate 6-3 are fixedly connected to the upper end and the lower end of the upper arc plate 6-1 respectively, the upper threaded rod 6-2 is connected to the pinion 5 at the upper end by threads, the upper end of the upper threaded rod 6-2 is slidably connected to the upper connecting plate 4; the lower closing plate 7 comprises a lower threaded rod 7-1, a lower arc plate 7-2 and a clamping groove 7-3, clamping groove 7-3 is arranged at the upper end of lower arc plate 7-2, the lower threaded rod 7-1 is fixedly connected to the lower end of the lower arc plate 7-2, the lower threaded rod 7-1 is connected to the pinion 5 at the lower end by threads, the lower end of the lower threaded rod 7-1 is slidably connected to the lower connecting plate 3, thread rotation direction of upper threaded rod 6-2 and lower threaded rod 7-1, the two pinions 5 respectively drive the upper threaded rod 6-2 and the lower threaded rod 7-1 to move up and down through threads, the thread directions of the upper threaded rod 6-2 and the lower threaded rod 7-1 are the same, the upper threaded rod 6-2 and the lower threaded rod 7-1 are close to or far away from each other, when the upper threaded rod 6-2 and the lower threaded rod 7-1 are close to each other, the upper threaded rod 6-2 and the lower threaded rod 7-1 respectively drive the upper arc plate 6-1 and the lower arc plate 7-2 to be close to each other, the clamping plates 6-3 are clamped in the clamping grooves 7-3, so that the two communication side plates 9-2 and the sealing sliding grooves are closed, the support body 9-1 is communicated when the upper threaded rod 6-2 and the lower threaded rod 7-1 are far away from each other, the upper threaded rod 6-2 and the lower threaded rod 7-1 respectively drive the upper arc plate 6-1 and the lower arc plate 7-2 to be far away from each other.

Specific Implementation Mode 6:

The present embodiment is described below with reference to FIGS. 1-18, the implementation mode 5 is further described in this embodiment. The anti-leakage self-sealing valve according to claim 5 is characterized in that the connecting support 9 which comprises a communication support body 9-1, a communication side plate 9-2 and a circular through hole □ 9-3; two communication side plates 9-2 are symmetrically arranged on the left side and the right side, both communication side plates 9-2 are fixedly connected in the communication support body 9-1, two communication side plates 9-2 forming a sealing sliding groove, two circular through holes □ 9-3 are symmetrically arranged in an up-and-down mode, two circular through holes □ 9-3 are internally provided with rotary rubber sealing rings, two circular through holes □ 9-3 are respectively arranged at the upper end and the lower end of the communication support body 9-1, the inner ends of the two conical connecting cylinders 8 are respectively fixed and communicated with the left end and the right end of the communication support body 9-1, the outer ends of the two conical connecting cylinders 8 are respectively fixed and communicated in the two valve cylinders 1-1, the upper arc plate 6-1 and the lower arc plate 7-2 pass through two circular through holes □ respectively 9-3 is in sliding connection with the two communication side plates 9-2 to form a sealing sliding groove; a rotary rubber sealing ring is arranged in each of the two circular through holes □ 9-3, and it can be guaranteed that the upper threaded rod 6-2 and the lower threaded rod 7-1 can effectively prevent external leakage during rotation.

Specific Implementation Mode 7:

The present embodiment is described below with reference to FIGS. 1-18, the implementation mode 6 is further described in this embodiment. The anti-leakage self-sealing valve according to claim 6 is characterized in that the connecting cylinder 10 comprises a connecting cylinder body 10-1, a quick clamping block 10-2 and a mounting groove □ 10-3; the sealing ring is arranged in mounting groove □ 10-3, two quick clamping blocks 10-2 are front and back symmetric arrangement, two quick clamping blocks 10-2 are fixedly connected to the front end and the rear end of the right side of the connecting cylinder 10-1 respectively, mounting groove □ 10-3 is arranged on the right side of the connecting cylinder 10-1, the two connecting cylinders 10-1 are respectively communicated with the outer side of the two valve cylinders 1-1 through two mounting grooves □ 10-3; sealing ring arranged in mounting groove □ 10-3 can effectively prevent external leakage.

Specific Implementation Mode 8:

The present embodiment is described below with reference to FIGS. 1-18, the implementation mode 7 is further described in this embodiment. The anti-leakage self-sealing valve according to claim 7 is characterized in that the clamping mechanism 11 comprises a clamping column 11-1, a connecting rod 11-2 and a clamping body 11-3; the connecting rod 11-2 and the clamping body 11-3 are fixedly connected to the front end and the rear end of the clamping column 11-1 respectively, four clamping columns 11-1 are respectively slidably connected in four circular through holes □ 1-5, four clamping bodies 11-3 are respectively clamped on four corresponding quick clamping blocks 10-2, compression springs □ are arranged on the four clamping columns 11-1, the compression spring □ is positioned between the clamping body 11-3 and the valve side plate □ 1-4; when the two connecting cylinders 10 are to be installed fast, and the two quick clamping blocks 10-2 on the connecting cylinder 10 are manually pushed to be clamped on the clamping body 11-3, the right ends of the two quick clamping blocks 10-2 are obliquely arranged, the inclined surfaces of the two clamping bodies 11-3 are matched with the two quick clamping blocks 10-2 to generate relative motion, the clamping body 11-3 extrudes the compression spring □ to move, and the left ends of the two quick clamping blocks 10-2 are obliquely arranged, the two quick clamping blocks 10-2 can be clamped on the two clamping bodies 11-3 to realize rapid installation.

Specific Implementation Mode 9:

The present embodiment is described below with reference to FIGS. 1-18, the implementation mode 8 is further described in this embodiment. The anti-leakage self-sealing valve according to claim 8 is characterized in that the disassembling mechanism 12 comprises a disassembling plate 12-1, a disassembling sliding column 12-2 and a disassembling side plate 12-3; two disassembling sliding column 12-2 and a disassembling side plate 12-3 are symmetrically arranged on the left side and the right side, the upper ends of the two disassembling sliding columns 12-2 are fixedly connected to a disassembling plate 12-1, the middle ends of the two disassembling side plates 12-3 are fixedly connected to the left end and the right end of the disassembling plate 12-1 respectively, two disassembling sliding columns 12-2 are respectively slidably connected in two circular through holes □ 4-1, two disassembling sliding columns 12-2 are respectively sleeved with a compression spring □, the compression spring □ is positioned between the disassembling plate 12-1 and the upper connecting plate 4, the inner ends of the four connecting rods 13 are hinged to the front end and the rear end of the two disassembling side plates 12-3 respectively, when the two connecting cylinders 10 need to be disassembled, the disassembling plate 12-1 is pushed manually to move downwards, and the disassembling plate 12-1 drives the two disassembling sliding columns 12-2 to move downwards, and the disassembling plate 12-1 extrudes the compression spring □, and the disassembling plate 12-1 drives the two disassembling side plates 12-3 to move downwards, the two disassembling side plates 12-3 push the inner ends of the four connecting rods 13 to move downwards, and the outer ends of the four connecting rods 13 are far away from each other, and the outer ends of the four connecting rods 13 are far away from each other and drive the outer ends of the four connecting rods 11-2 to be far away from each other, the four connecting rods 11-2 drive the four clamping bodies 11-3 to be far away from each other, the four clamping bodies 11-3 are not clamped on the four quick clamping blocks 10-2, the four quick clamping blocks 10-2 can be disassembled.

Specific Implementation Mode 10:

The present embodiment is described below with reference to FIGS. 1-18, the implementation mode 9 is further described in this embodiment. The anti-leakage self-sealing valve according to claim 9 is characterized in that the one-way mechanism 14 comprises a one-way plate 14-1, a one-way conical plate 14-2 and a rectangular column 14-3; a rectangular column 14-3 is slidably connected to a one-way plate 14-1, one-way conical plate 14-2 is fixedly connected to the left end of rectangular column 14-3, compression spring □ is on rectangular column 14-3, the compression spring □ is positioned between the one-way plate 14-1 and the one-way conical plate 14-2, one-way plate 14-1 is provided with a plurality of through holes, one-way plate 14-1 is fixedly connected in valve cylinder 1-1 positioned at the right end, one-way conical plate 14-2 is positioned in connecting cylinder 10-1 at right end, the inner diameter of the connecting cylinder 10-1 is smaller than the inner diameter of the valve cylinder 1-1; when the liquid flows from left to right, and a plurality of through holes are formed in the one-way plate 14-1 to push the one-way conical plate 14-2, and the inner diameter of the connecting cylinder body 10-1 is smaller than the inner diameter of the valve cylinder 1-1, the one-way conical plate 14-2 is used for blocking the liquid which is positioned on the right side of the connecting cylinder body 10-1 and cannot circulate; when the liquid flows from the right to the left end, the liquid can push the one-way conical plate 14-2, and the one-way conical plate 14-2 extrudes the compression spring iii to move leftwards, the one-way conical plate 14-2 does not block liquid in the connecting cylinder body 10-1, and the liquid can be circulated, the one-way mechanism 14 can control the flow direction of the liquid in the device so as to achieve better leakage prevention.

The invention discloses an anti-leakage self-sealing valve, and the working principle of the anti-leakage self-sealing valve is as follows:

During use, the rotating handle 2-3 on one side is rotated manually, and the rotating handle 2-3 is rotated to drive the rotating column 2-2 to rotate, the rotating column 2-2 drives the rotating gear body 2-1 to rotate. The two rotating gears 2-1 drive the two pinions 5 to rotate, the rotating directions of the two rotating gear bodies 2-1 are opposite; the rotating directions of the two pinions 5 are opposite. The two pinions (5) respectively drive the upper threaded rod 6-2 and the lower threaded rod 7-1 to move up and down through threads, the thread directions of the upper threaded rod 6-2 and the lower threaded rod 7-1 are the same, the upper threaded rod 6-2 and the lower threaded rod 7-1 are close to or far away from each other, when the upper threaded rod 6-2 and the lower threaded rod 7-1 are close to each other, the upper threaded rod 6-2 and the lower threaded rod 7-1 respectively drive the upper arc plate 6-1 and the lower arc plate 7-2 to be close to each other, the clamping plates 6-3 are clamped in the clamping grooves 7-3, so that the two communication side plates 9-2 and the sealing sliding grooves are closed, the support body 9-1 is communicated when the upper threaded rod 6-2 and the lower threaded rod 7-1 are far away from each other, the upper threaded rod 6-2 and the lower threaded rod 7-1 respectively drive the upper arc plate 6-1 and the lower arc plate 7-2 to be far away from each other. A rotary rubber sealing ring is arranged in each of the two circular through holes □ 9-3, and it can be guaranteed that the upper threaded rod 6-2 and the lower threaded rod 7-1 can effectively prevent external leakage during rotation. When the two connecting cylinders 10 are to be installed fast, and the two quick clamping blocks 10-2 on the connecting cylinder 10 are manually pushed to be clamped on the clamping body 11-3, the right ends of the two quick clamping blocks 10-2 are obliquely arranged, the inclined surfaces of the two clamping bodies 11-3 are matched with the two quick clamping blocks 10-2 to generate relative motion, the clamping body 11-3 extrudes the compression spring I to move, and the left ends of the two quick clamping blocks 10-2 are obliquely arranged, the two quick clamping blocks 10-2 can be clamped on the two clamping bodies 11-3 to realize rapid installation. When the two connecting cylinders 10 need to be disassembled, the disassembling plate 12-1 is pushed manually to move downwards, and the disassembling plate 12-1 drives the two disassembling sliding columns 12-2 to move downwards, and the disassembling plate 12-1 extrudes the compression spring II, and the disassembling plate 12-1 drives the two disassembling side plates 12-3 to move downwards, the two disassembling side plates 12-3 push the inner ends of the four connecting rods 13 to move downwards, and the outer ends of the four connecting rods 13 are far away from each other, and the outer ends of the four connecting rods 13 are far away from each other and drive the outer ends of the four connecting rods 11-2 to be far away from each other, the four connecting rods 11-2 drive the four clamping bodies 11-3 to be far away from each other, the four clamping bodies 11-3 are not clamped on the four quick clamping blocks 10-2, the four quick clamping blocks 10-2 can be disassembled. When the liquid flows from left to right, and a plurality of through holes are formed in the one-way plate 14-1 to push the one-way conical plate 14-2, and the inner diameter of the connecting cylinder body 10-1 is smaller than the inner diameter of the valve cylinder 1-1, the one-way conical plate 14-2 is used for blocking the liquid which is positioned on the right side of the connecting cylinder body 10-1 and cannot circulate; when the liquid flows from the right to the left end, the liquid can push the one-way conical plate 14-2, and the one-way conical plate 14-2 extrudes the compression spring iii to move leftwards, the one-way conical plate 14-2 does not block liquid in the connecting cylinder body 10-1, and the liquid can be circulated, the one-way mechanism 14 can control the flow direction of the liquid in the device so as to achieve better leakage prevention.

Definitely, the above description is not a limitation of the present invention and is not limited to the above examples. Variations, modifications, additions, or substitutions made within the essential scope of the invention by general technicians in the field of operation are also belong to the protection scope of the invention.

1. The anti-leakage self-sealing valve comprises a valve support (1), a rotary gear (2), a lower connecting plate (3), an upper connecting plate (4) and a pinion (5), an upper closing plate (6), a lower closing plate (7) and a conical connecting cylinder (8), a connecting support (9), a connecting cylinder (10), a clamping mechanism (11) and a disassembling mechanism (12), a connecting rod (13) and a one-way mechanism (14), and is characterized in that the valve support (1) and the rotary gear (2) are respectively and symmetrically provided with two, and the two rotary gears (2) are respectively and rotationally connected to the inner sides of the two valve supports (1), the left end and the right end of the lower connecting plate (3) are fixedly connected to the two valve supports (1) respectively. The left end and the right end of the upper connecting plate (4) are fixedly connected to the two valve supports (1) respectively, the upper connecting plate (4) is positioned at the upper end of the lower connecting plate (3); two pinions (5) which are symmetrically arranged in an up-and-down mode, the two ends of the two pinions (5) are respectively engaged with the inner sides of the two rotary gears (2), and the upper closing plate (6) is connected to the pinion (5) positioned at the upper end through threads; the lower closing plate (7) is connected to the pinion (5) positioned at the lower end through threads, the upper end of the upper closing plate (6) is slidably connected to the upper connecting plate (4), and the lower end of the lower closing plate (7) is slidably connected to the lower connecting plate (3); two conical connecting cylinders (8) are symmetrically arranged on the left side and the right side, the outer ends of the two conical connecting cylinders (8) are fixedly communicated with the two valve supports (1) respectively, the inner ends of the two conical connecting cylinders (8) are fixedly communicated with the left end and the right end of the connecting support (9) respectively, the lower end of the upper closing plate (6) is slidably connected to the connecting support (9), the upper end of the lower closing plate (7) is slidably connected to the connecting support (9), two connecting cylinders are symmetrically arranged on the left side and the right side, four clamping mechanisms (11) are symmetrically arranged, and the four clamping mechanisms (11) are respectively and slidably connected to the two valve supports (1) the front end and the rear end of the outer side, a compression spring I is arranged between the four clamping mechanisms (11) and the valve support (1), the two connecting cylinders (10) are respectively clamped on the outer sides of the two valve supports (1) through four clamping mechanisms (11), the disassembling mechanism is slidably connected to the upper connecting plate (4) and a compression spring II is arranged between the disassembling mechanism (12) and the upper connecting plate (4), four connecting rods (13) are symmetrically arranged, the inner ends of the four connecting rods (13) are hinged to the disassembling mechanism (11), and the four rods (13) is hinged to the four clamping mechanisms (11) respectively, the inner ends of the four connecting rods (13) are inclined upwards, the left end of the one-way mechanism (14) is fixedly connected to the valve support (1) positioned at the right end, and the one-way mechanism (14) is in interference fit with the connecting cylinder (10) positioned at the right end.

2. The anti-leakage self-sealing valve according to claim 1 is characterized in that the valve support (1) comprises a valve cylinder (1-1), a valve lower support (1-2) and a valve side plate I (1-3); a valve side plate II (1-4) and a circular through hole I (1-5), the lower support (1-2) of the valve is fixedly connected to the lower end of the valve cylinder (1-1), four valve side plates I (1-3) are symmetrically arranged, the four valve side plates I (1-3) are fixedly connected to the front end and the rear end of the valve cylinder (1-1) respectively, valve side plates II (1-4) are fixedly connected between the two valve side plates I (1-3) at the front end and the rear end, circular through holes I (1-5) are formed in the two valve side plates II (1-4).

3. The anti-leakage self-sealing valve according to claim 2 is characterized in that the rotary gear (2) comprises a rotating gear body (2-1), a rotating column (2-2), a rotating handle (2-3), a gear groove (2-4) and a mounting groove I (2-5); a sealing gasket is arranged in the mounting groove I (2-5), a plurality of rotating columns (2-2) are arranged, a plurality of rotating columns (2-2) are uniformly and fixedly connected to the rotating gear body (2-1) in the circumferential direction, a rotating handle (2-3) is fixedly connected to the outer side of the plurality of rotating columns (2-2), the gear groove (2-4) and the mounting groove I (2-5) are respectively arranged at the left and right ends of the rotating gear body (2-1), two rotary gears (2) are symmetrically arranged on the left side and the right side, the outer ends of the two rotating gear bodies (2-1) pass through the two mounting grooves I (2-5) respectively is connected to the inner side of the two valve cylinders (1-1) in a rotating mode.

4. The anti-leakage self-sealing valve according to claim 3 is characterized in that the left end and the right end of the lower connecting plate (3) are fixedly connected to the two valve cylinders (1) respectively; two circular through holes II (4-1) are formed in the upper connecting plate (4), the left end and the right end of the upper connecting plate (4) are fixedly connected to the two valve cylinders (1-1) respectively, the left end and the right end of the two pinions (5) are respectively meshed with the teeth in the two gear grooves (2-4).

5. The anti-leakage self-sealing valve according to claim 4 is characterized in that the upper closing plate (6) comprises an upper arc plate (6-1), an upper threaded rod (6-2) and a clamping plate (6-3); the upper threaded rod (6-2) and the clamping plate (6-3) are fixedly connected to the upper end and the lower end of the upper arc plate (6-1) respectively, the upper threaded rod (6-2) is connected to the pinion (5) at the upper end by threads, the upper end of the upper threaded rod (6-2) is slidably connected to the upper connecting plate (4); the lower closing plate (7) comprises a lower threaded rod (7-1), a lower arc plate (7-2) and a clamping groove (7-3), clamping groove (7-3) is arranged at the upper end of lower arc plate (7-2), the lower threaded rod (7-1) is fixedly connected to the lower end of the lower arc plate (7-2), the lower threaded rod (7-1) is connected to the pinion (5) at the lower end by threads, the lower end of the lower threaded rod (7-1) is slidably connected to the lower connecting plate (3), thread rotation direction of upper threaded rod (6-2) and lower threaded rod (7-1).

6. The anti-leakage self-sealing valve according to claim 5 is characterized in that the connecting support (9) which comprises a communication support body (9-1), a communication side plate (9-2) and a circular through hole III (9-3); two communication side plates (9-2) are symmetrically arranged on the left side and the right side, both communication side plates (9-2) are fixedly connected in the communication support body (9-1), two communication side plates (9-2) forming a sealing sliding groove, two circular through holes III (9-3) are symmetrically arranged in an up-and-down mode, two circular through holes III (9-3) are internally provided with rotary rubber sealing rings, two circular through holes III (9-3) are respectively arranged at the upper end and the lower end of the communication support body (9-1), the inner ends of the two conical connecting cylinders (8) are respectively fixed and communicated with the left end and the right end of the communication support body (9-1), the outer ends of the two conical connecting cylinders (8) are respectively fixed and communicated in the two valve cylinders (1-1), the upper arc plate (6-1) and the lower arc plate (7-2) pass through two circular through holes III respectively (9-3) is in sliding connection with the two communication side plates (9-2) to form a sealing sliding groove.

7. The anti-leakage self-sealing valve according to claim 6 is characterized in that the connecting cylinder (10) comprises a connecting cylinder body (10-1), a quick clamping block (10-2) and a mounting groove II (10-3); the sealing ring is arranged in mounting groove II (10-3), two quick clamping blocks (10-2) are front and back symmetric arrangement, two quick clamping blocks (10-2) are fixedly connected to the front end and the rear end of the right side of the connecting cylinder (10-1) respectively, mounting groove II (10-3) is arranged on the right side of the connecting cylinder (10-1), the two connecting cylinders (10-1) are respectively communicated with the outer side of the two valve cylinders (1-1) through two mounting grooves II (10-3).

8. The anti-leakage self-sealing valve according to claim 7 is characterized in that the clamping mechanism (11) comprises a clamping column (11-1), a connecting rod (11-2) and a clamping body (11-3); the connecting rod (11-2) and the clamping body (11-3) are fixedly connected to the front end and the rear end of the clamping column (11-1) respectively, four clamping columns (11-1) are respectively slidably connected in four circular through holes I (1-5), four clamping bodies (11-3) are respectively clamped on four corresponding quick clamping blocks (10-2), compression springs I are arranged on the four clamping columns (11-1), the compression spring I is positioned between the clamping body (11-3) and the valve side plate II (1-4).

9. The anti-leakage self-sealing valve according to claim 8 is characterized in that the disassembling mechanism (12) comprises a disassembling plate (12-1), a disassembling sliding column (12-2) and a disassembling side plate (12-3); two disassembling sliding column (12-2) and a disassembling side plate (12-3) are symmetrically arranged on the left side and the right side, the upper ends of the two disassembling sliding columns (12-2) are fixedly connected to a disassembling plate (12-1), the middle ends of the two disassembling side plates (12-3) are fixedly connected to the left end and the right end of the disassembling plate (12-1) respectively, two disassembling sliding columns (12-2) are respectively slidably connected in two circular through holes II (4-1), two disassembling sliding columns (12-2) are respectively sleeved with a compression spring II, the compression spring II is positioned between the disassembling plate (12-1) and the upper connecting plate (4), the inner ends of the four connecting rods (13) are hinged to the front end and the rear end of the two disassembling side plates (12-3) respectively.

10. The anti-leakage self-sealing valve according to claim 9 is characterized in that the one-way mechanism (14) comprises a one-way plate (14-1), a one-way conical plate (14-2) and a rectangular column (14-3); a rectangular column (14-3) is slidably connected to a one-way plate (14-1), one-way conical plate (14-2) is fixedly connected to the left end of rectangular column (14-3), compression spring III is on rectangular column (14-3), the compression spring III is positioned between the one-way plate (14-1) and the one-way conical plate (14-2), one-way plate (14-1) is provided with a plurality of through holes, one-way plate (14-1) is fixedly connected in valve cylinder (1-1) positioned at the right end, one-way conical plate (14-2) is positioned in connecting cylinder (10-1) at right end, the inner diameter of the connecting cylinder (10-1) is smaller than the inner diameter of the valve cylinder (1-1).
